(19) United States
(12) Patent Application Publication
(10) Pub. No.: US 2025/0363330 A1
(43) Pub. Date: Nov. 27, 2025

(54) GUIDING A DIFFUSION MODEL WITH AN INFERIOR VERSION OF ITSELF

(71) Applicant: NVIDIA Corporation, Santa Clara, CA (US)

(72) Inventors: Tero Tapani Karras, Helsinki (FI); Miika Aittala, Uusimaa (FI); Jaakko T. Lehtinen, Helsinki (FI); Timo Oskari Aila, Tuusula (FI); Samuli Matias Laine, Vantaa (FI)

(21) Appl. No.: 19/189,072

(22) Filed: Apr. 24, 2025

Related U.S. Application Data
(60) Provisional application No. 63/651,860, filed on May 24, 2024.

(51) Int. Cl. G06N 3/045; G06N 3/096

(52) U.S. Cl. CPC G06N 3/045; G06N 3/096

(57) ABSTRACT

Diffusion models are machine learning algorithms implemented as neural network-based denoisers that are uniquely trained to generate high-quality data from an input lower-quality data. To control the output image, the denoiser is typically conditioned on a conditioning input. However, since the training objective of a diffusion model aims to cover the entire (conditional) data distribution, this causes problems in low-probability regions. The present disclosure guides inferencing of a diffusion model with an inferior version of itself, which can improve image quality, for both conditional and unconditional diffusion models.

### CLAIM OF PRIORITY

This application claims the benefit of U.S. Provisional Application No. 63/651,860 (Attorney Docket No. NVIDP1406+/24-HE-0667US01) titled “GUIDING A DIFFUSION MODEL WITH AN INFERIOR VERSION OF ITSELF,” filed May 24, 2024, the entire contents of which is incorporated herein by reference.

### TECHNICAL FIELD

The present disclosure relates to generative modeling using denoising diffusion models.

### BACKGROUND

Diffusion models are machine learning algorithms that are capable of generating high-quality data—such as images, video, text, or audio—from scratch. Diffusion models are typically trained by adding varying amounts of (Gaussian) noise to the training data in a forward diffusion process and then learning to remove the noise in a reverse diffusion process. When the amount of noise is sufficiently large, the original data is effectively lost in the forward diffusion process. Thus, it is possible to generate completely novel data by starting from pure random noise and then following the reverse diffusion process to reveal a novel realization of clean data. In practice, this is achieved by repeatedly applying the learned diffusion model to gradually denoise the data over multiple—typically a few dozen—denoising steps.

Generally, a neural network-based implementation of a denoiser will perform the denoising process. To control the output image, the denoiser is typically conditioned on a class label, an embedding of a text prompt, or some other form of conditioning input. The training objective of a diffusion model aims to cover the entire (conditional) data distribution. This causes problems in low-probability regions, namely the model gets heavily penalized for not representing them, but it does not have enough data to learn to generate good images corresponding to them.

Classifier-free guidance has become the standard method for focusing the generation on well-learned high-probability regions. By training a denoiser network to operate in both the conditional and unconditional setting, the sampling process can be steered away from the unconditional result such that, in effect, the unconditional generation task specifies a result to avoid. This results in better prompt alignment and improved image quality, where the former effect is due to classifier-free guidance implicitly raising the conditional part of the probability density to a power greater than one.

However, classifier-free guidance has drawbacks that limit its usage as a general sampling method. First, it is applicable only for conditional generation, as the guidance signal is based on the difference between conditional and unconditional denoising results. Second, because the unconditional and conditional denoisers are trained to solve a different task, the sampling trajectory can overshoot the desired conditional distribution, which leads to skewed and often overly simplified image compositions. Finally, the prompt alignment and quality improvement effects cannot be controlled separately, and it remains unclear how exactly they relate to each other.

There is a need for addressing these issues and/or other issues associated with the prior art. The present disclosure is a method to guide inferencing of a diffusion model with an inferior version of itself, which does not suffer from the task discrepancy problem because an inferior version of the main model itself is being used as the guiding model, which can be accomplished with unchanged conditioning or even for an unconditional diffusion process.

### SUMMARY

A method, computer readable medium, and system are disclosed to guide inferencing of a diffusion model. Inferencing of a first diffusion model is guided using a second diffusion model to generate inferenced data, where the first diffusion model and the second diffusion model are configured to solve a same task, and where the second diffusion model is inferior to the first diffusion model in at least one respect. The inferenced data is output.

### BRIEF DESCRIPTION OF THE DRAWINGS

FIG. 1 illustrates a flowchart of a method to guide inferencing of a diffusion model, in accordance with an embodiment.

FIG. 2A illustrates a visualization of various sampling methods, in accordance with an embodiment.

FIG. 2B illustrates a visualization of probability densities, in accordance with an embodiment.

FIG. 3 illustrates a block diagram of a system configured to perform one step of denoising, in accordance with an embodiment.

FIG. 4 illustrates a flowchart of a method to generate a novel content from pure noise, in accordance with an embodiment.

FIG. 5A illustrates inference and/or training logic, according to at least one embodiment;

FIG. 58 illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

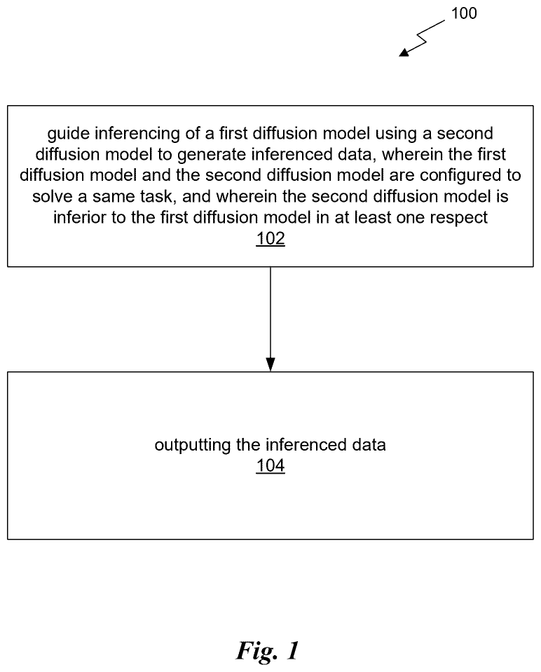

FIG. 1 illustrates a flowchart of a method 100 to guide inferencing of a diffusion model, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100 In another embodiment, a non-transitory computer-readable media may store computer instructions which when executed by one or more processors of a device cause the device to perform the method 100

As mentioned, the method 100 relates specifically to an inferencing process of a diffusion model. A diffusion model refers to a machine learning model that has learned to perform a denoising process in which noise is gradually removed from a given input to result in a denoised output. In an embodiment, the diffusion model is trained with a forward diffusion process in which noise is added to training data to form noisy data and a reverse diffusion process in which the model learns to remove the noise from the noisy data over a plurality of steps. In the present embodiment, the noise refers to (e.g. random or pseudo-random) artifacts that are artificially introduced in the data. The inferencing process, in an embodiment, refers to an inference-time or test-time execution of the diffusion model in which inferenced data (i.e. output) is generated, as described below.

Returning to the method 100, in operation 102, inferencing of a first diffusion model is guided using a second diffusion model to generate inferenced data. In an embodiment, the first diffusion model and/or the second diffusion model may be conditional diffusion models. For example, the first diffusion model and/or the second diffusion model may perform inferencing conditioned on an input prompt, such as a text. In another embodiment, the first diffusion model and/or the second diffusion model may be unconditional diffusion models, for example that perform inferencing without a conditioning input prompt.

With respect to the present description, the first diffusion model and the second diffusion model are configured (e.g. trained) to solve a same task. For example, the first diffusion model and the second diffusion model may be configured to solve a same task by using a same training process to train the first diffusion model and the second diffusion model towards a same training objective. The task may be a content generation task, such as image generation, video generation, audio generation, text generation, etc.

Also with respect to the present description, the second diffusion model is inferior to the first diffusion model in at least one respect. In an embodiment, the second diffusion model may be inferior to the first diffusion model as a result of the second diffusion model being of a smaller size (e.g. capacity) than the first diffusion model. In an embodiment, the second diffusion model may be inferior to the first diffusion model as a result of the second diffusion model having fewer trainable parameters than the first diffusion model. For example, the second diffusion model may include fewer layers than the first diffusion model, fewer feature channels per layer than the first diffusion model, etc. In an embodiment, the second diffusion model may be inferior to the first diffusion model as a result of the second diffusion model being configured with less complexity than the first diffusion model. For example, the second diffusion model may include fewer operations than the first diffusion model.

In an embodiment, the second diffusion model may be inferior to the first diffusion model as a result of the second diffusion model being trained over fewer iterations than the first diffusion model. For example, during training of the first diffusion model over a plurality of training iterations, the second diffusion model may be obtained by taking a snapshot of a state of the first diffusion model at an intermediate training iteration of the plurality of training iterations. In another example, the first diffusion model and the second diffusion model are trained separately (e.g. with the second diffusion model being trained over the fewer iterations than the first diffusion model). In an embodiment, the second diffusion model may be inferior to the first diffusion model as a result of the first diffusion model being a finetuned version of the second diffusion model. The first diffusion model may be finetuned by being trained further than the second diffusion model, for example by being further trained with additional training data and additional training steps.

While the second diffusion model is inferior to the first diffusion model in at least one respect, the second diffusion model and the first diffusion model may exhibit some similarities. These similarities may allow the first and second diffusion probabilistic models to be used in combination with one another, as described herein, to denoise a same input. As mentioned above, the first diffusion model and the second diffusion model are configured at least to solve a same task. In an additional embodiment, the first diffusion model and the second diffusion model may be configured with a same architecture. In another embodiment, the first diffusion model and the second diffusion model may be trained on a same training dataset or substantially similar training datasets or on a same data distribution. In an embodiment, the first diffusion model and the second diffusion model may be configured with a same input and output shape, which may allow guidance of the first diffusion model using the output of the second diffusion model. In any case, the second diffusion model may be required to exhibit the same kinds of degradations that the first diffusion model suffers from.

As mentioned above, inferencing of the first diffusion model is guided using the second diffusion model to generate inferenced data. Guiding the inferencing of the first diffusion model refers to the first diffusion model using an output of the second diffusion model during inferencing. In an embodiment, both the first diffusion model and the second diffusion model may process the same (i.e. noisy) input in each denoising step, but with the output of the second diffusion model guiding the processing of the input by the first diffusion model to generate the inferenced data for the next denoising step.

In an embodiment, guiding inferencing of the first diffusion model using the second diffusion model may include processing an input by the second diffusion model to generate a first output, and using the first output to guide processing of the input by the first diffusion model to generate a second output. In this embodiment the second output may be the inferenced data generated by the first diffusion model. In an embodiment, using the first output to guide processing of the input by the first diffusion model may include processing the input by the first diffusion model to generate an intermediate output, and boosting a difference of the intermediate output to the first output to result in the second output. In another embodiment, using the first output to guide processing of the input by the first diffusion model may include processing the input by the first diffusion model to generate an intermediate output, and extrapolating between the first output and the intermediate output to result in the second output.

In operation 104, the inferenced data is output when all the denoising steps have been executed. As described above, the first diffusion model may be configured to solve a particular task, such as the generation of content. To this end, the inferenced data that it output may be the content (e.g. image, video, text, audio, etc.) generated by the first diffusion model. In an embodiment, the inferenced data may be output to a display device. In another embodiment, the inferenced data may be output to a downstream application for further processing thereof. Just by way of example, where the inferenced data is an image or video, the inferenced data may be output to a virtual reality (VR) application or augmented reality (AR) application for use in generating and outputting VR/AR content (e.g. to a VR/AR headset device).

In an embodiment, guiding inferencing of the first diffusion model using the second diffusion model may improve a quality of an output (i.e. the inferenced data) of the first diffusion model. For example, disentangled control over content quality may be provided via the method 100 described above without compromising the amount of variation, which is otherwise not possible in prior art solutions that guide a diffusion model with an entirely different unconditional model. Furthermore, the present method 100 may be carried out even when the first diffusion model is an unconditional model, which has not previously been possible with prior art solutions. Still yet, since the first and second diffusion models are configured to solve a same task, the inferenced data may not exhibit the skewed and/or overly simplified content compositions otherwise exhibited in the prior art solutions where the models are trained to solve different tasks.

Further embodiments will now be provided in the description of the subsequent figures. It should be noted that the embodiments disclosed herein with reference to the method 100 of FIG. 1 may apply to and/or be used in combination with any of the embodiments of the remaining figures below.

### Background on Denoising Diffusion

Denoising diffusion generates samples from a distribution p_{data}(x) by iteratively denoising a sample of (e.g. pure white) noise, such that a noise-free random data sample is gradually revealed. The idea is to consider heat diffusion of p_{data}(x) into a sequence of increasingly smoothed densities p(x; σ)=p_{data}(x)*N(x; 0, σ²I). For a large enough σₘₐₓ, the smoothed density is virtually indistinguishable from pure noise, i.e.,

$$p ( x ; {σ}_{max} ) \approx N ( x ; {σ}_{max}^{2} I ) ,$$

which can be trivially sampled from by drawing normally distributed white noise. The resulting sample is then evolved backward towards low noise levels by a probability flow ordinary differential equation (ODE) per Equation 1.

$${dx}_{σ} = - σ {∇}_{{x}_{σ}} log p ( {x}_{σ} ; σ ) d σ \qquad Equation 1$$

where the property x_{σ}˜p(x_{σ}; σ) is maintained for every σ∈[0, σₘₐₓ]. Upon reaching σ=0, x₀˜p(x₀; 0)=p_{data}(x₀) is obtained as desired.

In practice, the ODE is solved numerically by stepping along the trajectory defined by Equation 1. This requires evaluating the so-called score function ∇ₓ log p(x; σ) for a given sample x and noise level σ at each step. This vector can be approximated using a neural network D_{θ}(x; σ) parameterized by weights θ trained for the denoising task per Equation 2.

$$θ = arg {min}_{θ} {𝔼}_{y \sim {p}_{data} , σ \sim {p}_{train} , n \sim N ( 0 , {σ}^{2} I )} {‖ {D}_{θ} ( y + n ; σ ) - y ‖}_{2}^{2} \qquad Equation 2$$

where pₜᵣₐᵢₙ controls the noise level distribution during training. Given D_{θ}, ∇ₓ log p(x; σ)≈(D_{θ}(x; σ)−x)/σ² can be estimated, up to approximation errors due to, e.g., finite capacity or training time. As such, the network can be interpreted as predicting either a denoised sample or a score vector, whichever is more convenient for the analysis at hand. Many reparameterizations and practical ODE solvers are possible. The schedule σ(t)=t may be used which allows ODE to be parameterized directly via noise level o instead of a separate time variable t.

In most applications, each data sample x is associated with a label c, representing, e.g., a class index or a text prompt. At generation time, the outcome can be controlled by choosing a label c and seeking a sample from the conditional distribution p(x|c; σ) with σ=0. In practice, this is achieved by training a denoiser network D_{θ}(x; σ, c) that accepts c as an additional conditioning input.

### Background on Classifier-Free Guidance

For complex visual datasets, the generated images often fail to reproduce the clarity of the training images due to approximation errors made by finite-capacity networks. A broadly used trick called classifier-free guidance pushes the samples towards higher likelihood of the class label, sacrificing variety for “more canonical” images that the network appears to be better capable of handling.

In a general setting, guidance in a diffusion model involves two denoiser networks D₀(x; σ, c) and D₁(x; σ, c). The guiding effect is achieved by extrapolating between the two denoising results by a factor w, per Equation 3.

$${D}_{w} ( x ; σ , c ) = {wD}_{1} ( x ; σ , c ) + ( 1 - w ) {D}_{0} ( x ; σ , c ) \qquad Equation 3$$

Trivially, setting w=0 or w=1 recovers the output of D₀ and D₁, respectively, while choosing w>1 over-emphasizes the output of D₁. Recalling the equivalence of denoisers and scores, Equation 4 can be defined.

$${D}_{w} ( x ; σ , c ) \approx x + {σ}^{2} {∇}_{x} log {\underbrace{{{p}_{0} ( x \vert c ; σ ) [ \frac{{p}_{1} ( x \vert c ; σ )}{{p}_{0} ( x \vert c ; σ )} ]}^{w}}}_{∝ : {p}_{w} ( x \vert c ; σ )} \qquad Equation 4$$

Thus, guidance grants access to the score of the density p_{w} (x|c; σ) implied in the parentheses. This score can be further written as per E question 5.

$${∇}_{x} log {p}_{w} ( x \vert c ; σ ) = {∇}_{x} log {p}_{1} ( x \vert c ; σ ) + ( w - 1 ) {∇}_{x} log \frac{{p}_{1} ( x \vert c ; σ )}{{p}_{0} ( x \vert c ; σ )} \qquad Equation 5$$

Substituting this expression into the ODE of Equation 1, this yields the standard evolution for generating images from p₁, plus a perturbation that increases (for w>1) the ratio of p₁ and p₀ as evaluated at the sample. The latter can be interpreted as increasing the likelihood that a hypothetical classifier would attribute for the sample having come from density p₁ rather than p₀.

In classifier-free guidance, an auxiliary unconditional denoiser D_{θ}(x; σ) is trained to denoise the distribution p(x; σ) marginalized over c, and this used as D₀. In practice, this is typically done using the same network De with an empty conditioning label, setting D₀:=D_{θ}(x; σ, Ø) and D₁:=D_{θ}(x; σ, c). By Bayes' rule, the extrapolated score vector becomes ∇ₓ log p(x|c; σ)+(w−1)∇ₓ log p(c|x; σ). During sampling, this guides the image to more strongly align with the specified class c.

Unfortunately, solving the diffusion ODE with the score function of Equation 5 does not produce samples from the data distribution specified by pw (x|c; 0), because pw (x|c; σ) does not represent a valid heat diffusion of pw (x|c; 0). Therefore, solving the ODE does not, in fact, follow the density. Instead, the samples are blindly pushed towards higher values of the implied density at each noise level during sampling. This can lead to distorted sampling trajectories, greatly exaggerated truncation, and mode dropping in the results, as well as over-saturation of colors. Nonetheless, the improvement in image quality is often remarkable, and high guidance values are commonly used despite the drawbacks.

### The reason why Classifier-Free Guidance Improves Image Quality

There is a mechanism by which classifier-free guidance improves image quality instead of only affecting prompt alignment.

### Score Matching Leads to Outliers

Compared to sampling directly from the underlying distribution, an unguided diffusion produces a large number of extremely unlikely samples outside the bulk of the distribution. In the image generation setting, these would correspond to unrealistic and broken images.

The outliers may stem from the limited capability of the score network combined with the score matching objective. It is well known that maximum likelihood (ML) estimation leads to a “conservative” fit of the data distribution in the sense that the model attempts to cover all training samples. This is because the underlying Kullback-Leibler divergence incurs extreme penalties if the model severely underestimates the likelihood of any training sample. While score matching is generally not equal to maximum likelihood (ML) estimation, they are closely related and appear to exhibit broadly similar behavior. For example, it is known that for a multivariate Gaussian model, the optimal score matching fit coincides with the ML estimate. For two models of different capacity at an intermediate noise level, the stronger model has been found to envelop the data more tightly, while the weaker model's density is more spread out.

From the perspective of image generation, a tendency to cover the entire training data becomes a problem: The model ends up producing strange and unlikely images from the data distribution's extremities that are not learnt accurately but included just to avoid the high loss penalties. Furthermore, during training, the network has only seen real noisy images as inputs, and during sampling it may not be prepared to deal with the unlikely samples it is handed down from the higher noise levels.

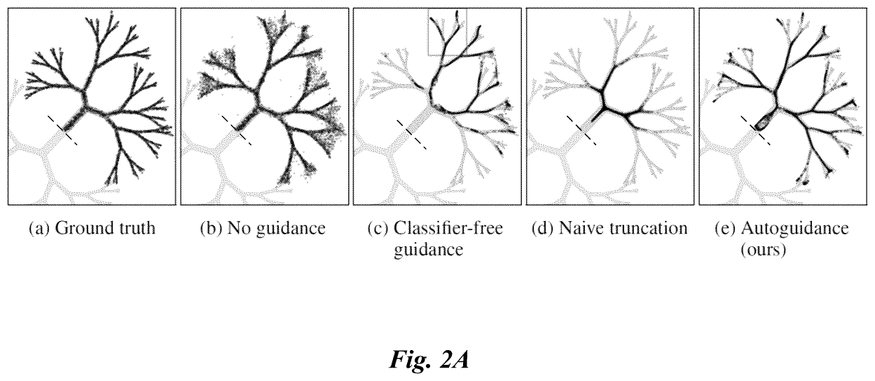

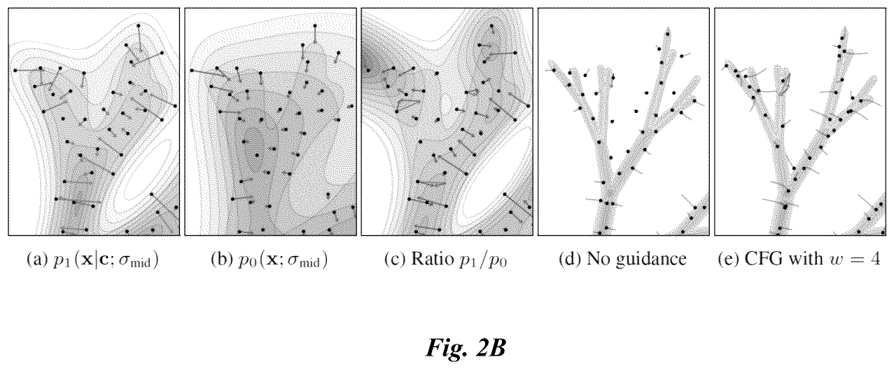

FIG. 2A illustrates a fractal-like two-dimension (2D) distribution with two classes indicated above and below the dotted line, respectively referred to as upper and lower classes. Approximately 99% of the probability mass is inside the shown contours. (a) Ground truth samples drawn directly from the upper class distribution. (b) Conditional sampling using a small denoising diffusion model generates outliers. (c) Classifier-free guidance (w=4) eliminates outliers but reduces diversity by over-emphasizing the class. (d) Naive truncation via lengthening the score vectors. (e) The method 100 concentrates samples on high-probability regions without reducing diversity.

### Classifier-Free Guidance Eliminates Outliers

The effect of applying classifier-free guidance during generation is that the samples avoid the class boundary, and entire branches of the distribution are dropped. A second phenomenon has also been observed, where the samples have been pulled in towards the core of the manifold, and away from the low-probability intermediate regions. Seeing that this eliminates the unlikely outlier samples, the image quality improvement may be attributed to it. However, mere boosting of the class likelihood does not explain this increased concentration.

This phenomenon may stem from a quality difference between the conditional and unconditional denoiser networks. The unconditional denoiser D₀ faces a more difficult task of the two: It has to generate from all classes at once, whereas the conditional denoiser D₁ can focus on a single class for any specific sample. Given the more difficult task, and typically only a small slice of the training budget, the network D₀ attains a worse fit to the data.

From the description of denoising diffusion and classifier-free guidance above, it follows that classifier-free guidance is not only boosting the likelihood of the sample having come from the class c, but also that of having come from the higher-quality implied distribution. Recall that guidance boils down to an additional force (Equation 5) that pulls the samples towards higher values of log [p₁(x|c; σ)/p₀(x|c; σ)]. It has been found that the ratio generally decreases with distance from the manifold due to the denominator p₀ representing a more spread-out distribution, and hence falling off slower than the numerator p₁. Consequently, the gradients point inward towards the data manifold. Each contour of the density ratio corresponds to a specific likelihood that a hypothetical classifier would assign on a sample being drawn from p₁ instead of p₀. Because the contours roughly follow the local orientation and branching of the data manifold, pushing samples deeper into the “good side” concentrates them at the manifold.

FIG. 2B illustrates a closeup of the region highlighted in FIG. 2A (c). The present illustration shows the following. (a) The implied learned density p₁(x|c; σ_{mid}) light gray) at an intermediate noise level σ_{mid} and its score vectors (log-gradients), plotted at representative sample points. The learned density approximates the underlying ground truth p(x|c; σ_{mid}) (dark gray) but fails to replicate its sharper details. (b) The weaker unconditional model learns a further spread-out density p₀(x; σ_{mid}) (light gray) with a looser fit to the data. (c) Guidance moves the points according to the gradient of the (log) ratio of the two learned densities (light gray). As the higher-quality model is more sharply concentrated at the data, this field tends inward towards the data distribution. The corresponding gradient is simply the difference of respective gradients in (a) and (b), illustrated at selected points. (d) Sampling trajectories taken by standard unguided diffusion following the learned score ∇ₓ log p₁(x|c; σ), from noise level σ_{mid} to 0. The contours (dark gray) represent the ground truth noise-free density. (e) Guidance introduces an additional force shown in (c), causing the points to concentrate at the core of the data density during sampling.

### Discussion

It can be expected that the two models will suffer from inability to fit at similar places, but to a different degree. The predictions of the denoisers will disagree more decisively in these regions. As such, classifier-free guidance can be seen as a form of adaptive truncation that identifies when a sample is likely to be under-fit and pushes it towards the general direction of better samples. Over the course of generation, the truncation will “overshoot” the correction and produce a narrower distribution than the ground truth, but in practice this does not appear to have an adverse effect on the images.

In contrast, a naive attempt at achieving this kind of truncation—inspired by, e.g., the truncation trick in generative adversarial networks (GANs) or lowering temperature in generative language models—would counteract the smoothing by uniformly lengthening the score vectors by a factor w>1. In practice, images generated this way tend to show reduced variation, oversimplified details, and monotone texture.

### Embodiments of the Present Disclosure—Autoguidance

The embodiments described herein, particularly as they relate to the method 100 of FIG. 1 differ from the prior solutions (including classifier-free guidance) to isolate the image quality improvement effect by directly guiding a higher-quality model D₁ with an inferior (e.g. poor) model D₀ trained on the same task (and optionally with the same conditioning and data distribution) but suffering from certain additional degradations, such as low capacity and/or under-training. This procedure may be referred to as “autoguidance,” as the model is guided with an inferior version of itself. The effect of using an inferior D₀with fewer training iterations is that the samples are pulled close to the distribution without systematically dropping any part of it.

As mentioned before, under limited model capacity, score matching tends to over-emphasize low-probability (i.e., implausible and under-trained) regions of the data distribution. Exactly where and how the problems appear depend on various factors such as network architecture, dataset, training details, etc., which cannot be specifically identified and characterized a priori. However, a weaker version of the same model can be expected to make broadly similar errors in the same regions, only stronger. In embodiments, autoguidance seeks to identify and reduce the errors made by the stronger model by measuring its difference to the weaker model's prediction, and boosting it. When the two models agree, the perturbation is insignificant, but when they disagree, the difference indicates the general direction towards better samples. As such, autoguidance can be expected to work if the two models suffer from degradations that are compatible with each other. Since any D₁ can be expected to suffer from, e.g., lack of capacity and lack of training—at least to some degree—it makes sense to choose D₀ so that it further exacerbates these aspects.

In some embodiments involving models D₁ and D₀ that are trained separately or for a different number of iterations, these models may differ not only in accuracy of fit, but also in terms of random initialization, shuffling of the training data, etc. For guidance to be successful in this case, the quality gap (i.e. the degree to which D₀ is inferior to D₁) should be large enough to make the systematic spreading-out of the density outweigh these random effects.

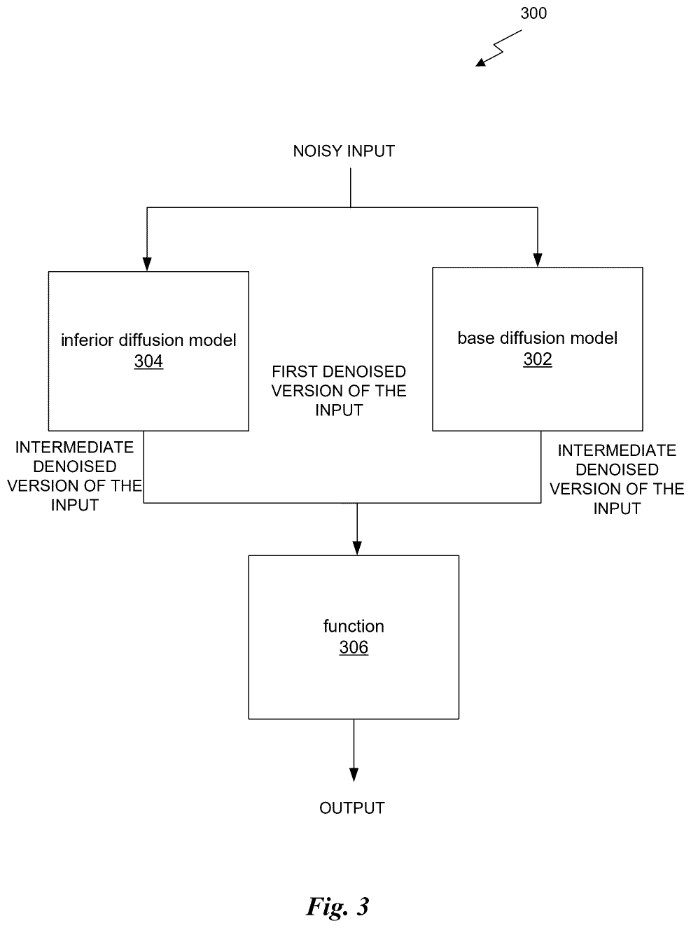

FIG. 3 illustrates a block diagram of a system 300 configured to perform one step of denoising, in accordance with an embodiment. The system 300 may be implemented to carry out the method 100 of FIG. 1 in an embodiment. Further, the descriptions and/or definitions given above may equally apply to the present embodiment.

As shown, a noisy input is provided to both a base diffusion model 302 and an inferior diffusion model 304. The base diffusion model 302 may be the first diffusion model described above with respect to FIG. 1 while the inferior diffusion model 304 may be the second diffusion model described above with respect to FIG. 1 In an embodiment, the base diffusion model 302 and the inferior diffusion model 304 may be conditional diffusion models or unconditional diffusion models. In any case, with respect to the present description, the base diffusion model 302 and the inferior diffusion model 304 are configured to solve a same task, and further the inferior diffusion model 304 is inferior to the base diffusion model 302 in at least one respect.

At inference time, the base diffusion model 302 processes the noisy input to generate its intermediate denoised version of the noisy input and the inferior diffusion model 304 processes the noisy input to generate its intermediate denoised version of the noisy input. In the embodiment where the models 302 304 are each a conditional diffusion model, the models 302 304 may each process the noisy input along with an input prompt (e.g. text) to generate their respective intermediate version of the noisy input. The intermediate denoised versions of the noisy input generated by the models 302 304 are processed by a function 306 to generate an output. The output refers to a denoised version of the noisy input. In an embodiment, the function 306 may boost a difference of the intermediate denoised versions of the noisy input to result in the output. In another embodiment, the function 306 may extrapolate between the intermediate denoised versions of the noisy input to result in the output.

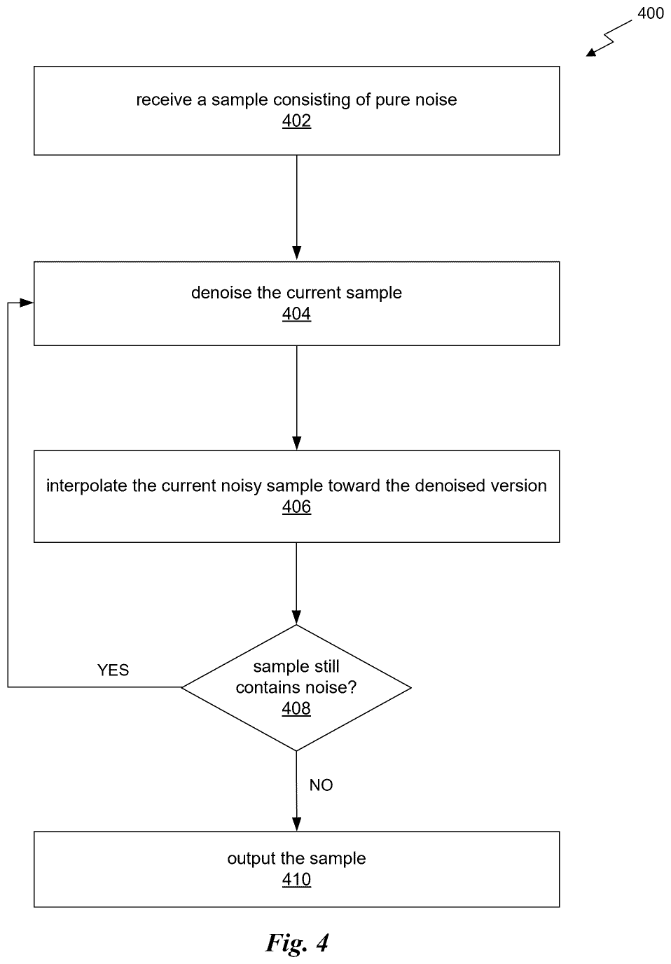

FIG. 4 illustrates a flowchart of a method 400 to generate novel content from pure noise, in accordance with an embodiment. The method 400 may be carried out in the context of any of the embodiments described above with reference to FIGS. 1-3 In an embodiment, the novel content may be an image.

In operation 402, a sample consisting of pure noise is received. In operation 404, the current sample is denoised (i.e. in accordance with FIG. 3). In operation 406, the current noisy sample is interpolated towards the denoised version (i.e. in accordance with the method 100 of FIG. 1). In decision 408, it is determined whether the sample still contains noise. For example, it may be determined whether the sample contains any noise or a predefined threshold level of noise. When it is determined that that the sample still contains noise, the method 400 returns to operation 404 to further denoise the sample. Once it is determined that the sample does not still contain noise, then the sample is output in operation 410

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

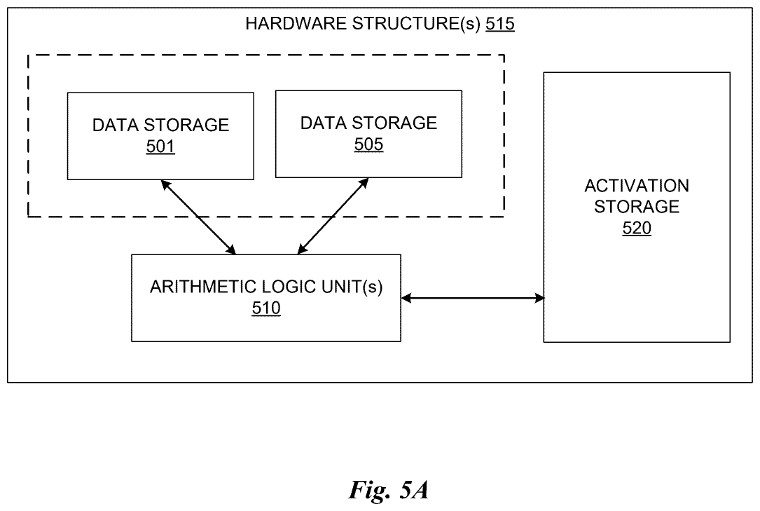

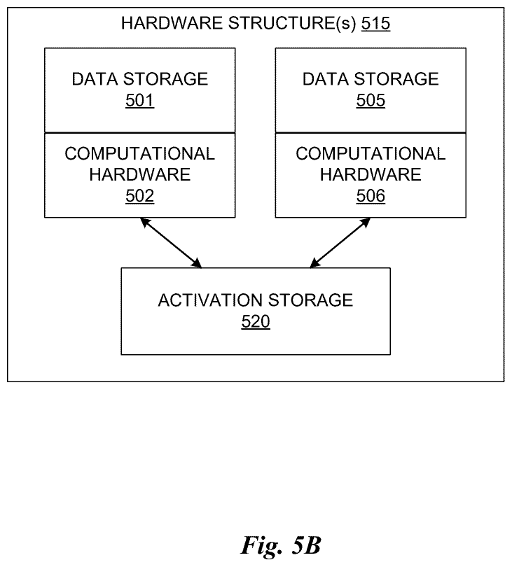

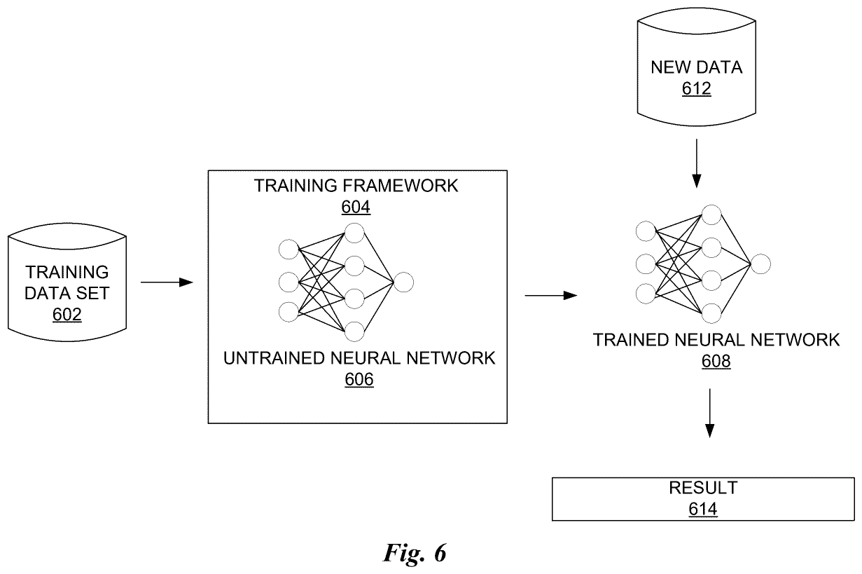

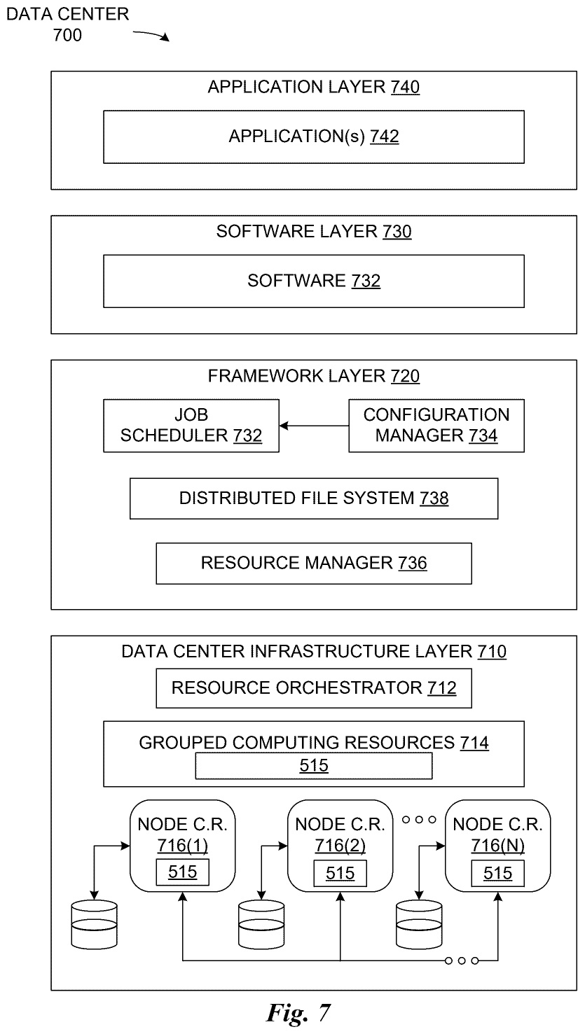

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505 In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515

### Neural Network Training and Deployment

FIG. 6 illustrates another embodiment for training and deployment of a deep neural network. In at least one embodiment, untrained neural network 606 is trained using a training dataset 602 In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608 In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606 In at least one embodiment, training framework 604 adjusts weights that control untrained neural network 606 In at least one embodiment, training framework 604 includes tools to monitor how well untrained neural network 606 is converging towards a model, such as trained neural network 608, suitable to generating correct answers, such as in result 614, based on known input data, such as new data 612 In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602 In at least one embodiment, unsupervised training can be used to generate a self-organizing map, which is a type of trained neural network 608 capable of performing operations useful in reducing dimensionality of new data 612 In at least one embodiment, unsupervised training can also be used to perform anomaly detection, which allows identification of data points in a new dataset 612 that deviate from normal patterns of new dataset 612

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

FIG. 7 illustrates an example data center 700, in which at least one embodiment may be used. In at least one embodiment, data center 700 includes a data center infrastructure layer 710, a framework layer 720, a software layer 730 and an application layer 740

In at least one embodiment, as shown in FIG. 7, data center infrastructure layer 710 may include a resource orchestrator 712 grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGA s), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714 In at least one embodiment, resource orchestrator 722 may include a software design infrastructure (“SDI”) management entity for data center 700 In at least one embodiment, resource orchestrator may include hardware, software or some combination thereof.

In at least one embodiment, as shown in FIG. 7, framework layer 720 includes a job scheduler 732 a configuration manager 734, a resource manager 736 and a distributed file system 738 In at least one embodiment, framework layer 720 may include a framework to support software 732 of software layer 730 and/or one or more application(s) 742 of application layer 740 In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700 In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732 In at least one embodiment, clustered or grouped computing resources may include grouped computing resource 714 at data center infrastructure layer 710 In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720 one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720 one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700 In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to guide inferencing of a diffusion model. In accordance with FIGS. 1-4, embodiments may provide multiple diffusion models usable for performing inferencing operations and for providing inferenced data. The diffusion models may be stored (partially or wholly) in one or both of data storage 501 and 505 in inference and/or training logic 515 as depicted in FIGS. 5A and 5. Training and deployment of the diffusion models may be performed as depicted in FIG. 6 and described herein. Distribution of the diffusion models may be performed using one or more servers in a data center 700 as depicted in FIG. 7 and described herein.

What is claimed is:

1. A method, comprising:
at a device:
guiding inferencing of a first diffusion model using a second diffusion model to generate inferenced data,
wherein the first diffusion model and the second diffusion model are configured to solve a same task, and
wherein the second diffusion model is inferior to the first diffusion model in at least one respect; and
outputting the inferenced data.

2. The method of claim 1, wherein the first diffusion model and the second diffusion model are configured to solve a same task by using a same training process to train the first diffusion model and the second diffusion model towards a same training objective.

3. The method of claim 2, wherein the first diffusion model and the second diffusion model are configured with a same architecture.

4. The method of claim 2, wherein the first diffusion model and the second diffusion model are trained on a same training dataset.

5. The method of claim 1, wherein the second diffusion model is inferior to the first diffusion model as a result of the second diffusion model being trained over fewer iterations than the first diffusion model.

6. The method of claim 5, wherein during training of the first diffusion model over a plurality of training iterations, the second diffusion model is obtained by taking a snapshot of a state of the first diffusion model at an intermediate training iteration of the plurality of training iterations.

7. The method of claim 5, wherein the first diffusion model and the second diffusion model are trained separately.

8. The method of claim 1, wherein the second diffusion model is inferior to the first diffusion model as a result of the second diffusion model having fewer trainable parameters than the first diffusion model.

9. The method of claim 8, wherein the second diffusion model includes fewer layers than the first diffusion model.

10. The method of claim 8, wherein the second diffusion model includes fewer feature channels per layer than the first diffusion model.

11. The method of claim 1, wherein the first diffusion model and the second diffusion model are conditional diffusion models.

12. The method of claim 11, wherein the first diffusion model and the second diffusion model perform inferencing conditioned on an input prompt.

13. The method of claim 12, wherein the input prompt is a text.

14. The method of claim 1, wherein the first diffusion model and the second diffusion model are unconditional diffusion models.

15. The method of claim 1, wherein guiding inferencing of the first diffusion model using the second diffusion model includes:
processing an input by the second diffusion model to generate a first output, and
using the first output to guide processing of the input by the first diffusion model to generate a second output.

16. The method of claim 15, wherein using the first output to guide processing of the input by the first diffusion model includes:
processing the input by the first diffusion model to generate an intermediate output, and
boosting a difference of the intermediate output to the first output to result in the second output.

17. The method of claim 15, wherein using the first output to guide processing of the input by the first diffusion model includes:
processing the input by the first diffusion model to generate an intermediate output, and
extrapolating between the first output and the intermediate output to result in the second output.

18. The method of claim 1, wherein the first diffusion model and the second diffusion model are configured to solve a same task by using a same training process to train the first diffusion model and the second diffusion model towards a same training objective, and wherein guiding inferencing of the first diffusion model using the second diffusion model includes:
processing an input by the second diffusion model to generate a first output, and
using the first output to guide processing of the input by the first diffusion model to generate a second output.

19. The method of claim 1, wherein guiding inferencing of the first diffusion model using the second diffusion model improves a quality of an output of the first diffusion model.

20. The method of claim 1, wherein the task is image generation.

21. The method of claim 1, wherein the task is video generation.

22. The method of claim 1, wherein the task is text generation.

23. The method of claim 1, wherein the task is audio generation.

24. A system, comprising:
a non-transitory memory storage comprising instructions; and
one or more processors in communication with the memory, wherein the one or more processors execute the instructions to:
guide inferencing of a first diffusion model using a second diffusion model to generate inferenced data,
wherein the first diffusion model and the second diffusion model are configured to solve a same task, and
wherein the second diffusion model is inferior to the first diffusion model in at least one respect; and
output the inferenced data.

25. The system of claim 24, wherein the first diffusion model and the second diffusion model are configured to solve a same task by using a same training process to train the first diffusion model and the second diffusion model towards a same training objective, and wherein guiding inferencing of the first diffusion model using the second diffusion model includes:
processing an input by the second diffusion model to generate a first output, and using the first output to guide processing of the input by the first diffusion model to generate a second output.

26. A non-transitory computer-readable media storing computer instructions which when executed by one or more processors of a device cause the device to:
guide inferencing of a first diffusion model using a second diffusion model to generate inferenced data,
wherein the first diffusion model and the second diffusion model are configured to solve a same task, and
wherein the second diffusion model is inferior to the first diffusion model in at least one respect; and
output the inferenced data.

27. The non-transitory computer-readable media of claim 26, wherein the first diffusion model and the second diffusion model are configured to solve a same task by using a same training process to train the first diffusion model and the second diffusion model towards a same training objective, and wherein guiding inferencing of the first diffusion model using the second diffusion model includes:
processing an input by the second diffusion model to generate a first output, and
using the first output to guide processing of the input by the first diffusion model to generate a second output.
